(19) United States
(12) Patent Application Publication
(10) Pub. No.: US 2024/0186573 A1
(43) Pub. Date: Jun. 6, 2024

(54) GEL POLYMER ELECTROLYTE BASED ON A CROSS-LINKED POLYMER

(71) Applicant: NAZARBAYEV UNIVERSITY AUTONOMOUS ORGANIZATION OR, Nur-Sultan (KZ)

(72) Inventors: ALMAGUL ABDYKALIMOVNA MENTBAYEVA, Nur-Sultan (KZ); ORYNBAY ZHANADILOV, Nur-Sultan (KZ); MYUNG SEUNG-TAEK, Seoul (KR); ZHUMABAY BEKBOLATOVICH BAKENOV, Nur-Sultan (KZ)

(21) Appl. No.: 18/286,122

(22) PCT Filed: Sep. 1, 2022
(86) PCT No.: PCT/KZ2022/000013

§ 371 Date: Oct. 7, 2023

(30) Foreign Application Priority Data
Sep. 10, 2021 (KZ) 2021/0549.1

(51) Int. Cl. H01M 10/0565

(52) U.S. Cl. CPC H01M 10/0565; H01M 2300/0085

(57) ABSTRACT

The invention relates to the electrochemical industry, and particularly to polymer gel electrolytes for secondary aqueous batteries.

The objective of the invention is to create a chemically cross-linked polymer electrolyte gel for secondary water batteries, which increases the electrochemical stability of water, thereby expanding the operating voltage range.

The technical result of the invention is to expand the operating voltage range by means of a chemically cross-linked polymer electrolyte gel for secondary water batteries. It provides high electrochemical stability and high ionic conductivity.

This technical result is achieved due to the fact that the invention proposes a cross-linked polymer, which consists of acrylamide (AA), [2-(Methacryloyloxy)ethyl]dimethyl-(3-sulfopropyl) (DMAPS) and N,N′-methylenebisacrylamide (MBA).

AA and DMAP are monomers and MBA is a coupling agent. An aqueous solution of an electrolyte salt in a crosslinked polymer structure to form a quasi-solid gel electrolyte material. The cross-linked polymer gel electrolyte is designed to be used both as a separator and as an electrolyte. It is placed between the negative (anode) and positive (cathode) electrodes. As a separator, it prevents direct contact of the electrodes, and as an electrolyte, it provides an environment in which ions pass from one electrode to another or from electrode to electrolyte and vice versa. AA amide group, DMAP cationic and anionic groups provide high ionic conductivity and strong water retention capacity in the crosslinked polymer gel electrolyte. The invention, due to its high ionic conductivity, has a high reversibility of the electrochemical reaction and high electrochemical stability due to the retention of water in the hydrophilic structure.

The invention relates to electrochemical industry, and particularly to polymer gel electrolytes for secondary aqueous batteries.

Fast growth of green energy production increases the demand in the large-scale energy storage systems, where the low cost and high fire safety are critically important. Current commercial Li-ion battery (LIBs) systems are still expensive, regardless the fact that their price is gradually reducing [Ziegler, Energy Environ. Sci. 2021, 14, 1635-1651], and most importantly LIBs have a serious fire safety issue due to the usage of flammable organic solvents [Diaz et al, J. Electrochem. Soc. 2020, 167, 090559]. Aqueous batteries are a promising technology for large scale energy storage since the possession of such important characteristics as low cost, low-toxicity and non-flammability of the materials. Due to these advantages aqueous batteries research emerged towards advanced aqueous batteries with various electrode couples and an array of electrolytes, that can be used in various applications from flexible and wearable devices to large-scale energy storage systems [A. J. F. Romero n et al., Polymers 2020, 12, 2812].

However, aqueous batteries possess several disadvantages that prevent commercialization of various rechargeable aqueous battery technologies. One of them is the narrow electrochemical stability window of water, i.e. limited operation voltage. It has a limited intrinsic oxidation potential due to use of water as a solvent, and the oxygen evolution reaction takes place and reduction potential with hydrogen evolution reaction that differ from each other by a potential window of 1.23 V [S. Z. Qiao et al., Science Advances 2020, 6, 21, caba4098]. Such narrow electrochemical stability window limits the battery operating potential that leads to an 24 insufficient energy density and reduces the number of applicable electrode pairs to combine a stable electrochemical battery. The most researched aqueous battery system is a cell with the electrode couple of zinc metal anode and manganese dioxide cathode that have a potential difference lower than 2 volts [C. Zhi et al, Current Opinion in Electrochemistry 2021, 30, 100769, 2451-9103]. Although there are various water-in-salt electrolyte technologies that solve the narrow operating potential issue, these electrolyte type dramatically increases the cost making it 30 an unattractive solution [G. Balakrishna et al, Sustainable Energy Fuels 2021, 5, 1619-1654].

One potential solution to the problem is to replace liquid electrolytes with a polymer gel electrolyte composition. Polymer gel electrolytes have a porous structure composed of hydrophilic polymer chains that are filled with an aqueous electrolyte. In addition to being flexible and mechanically strong, these gels have high ionic conductivity and can protect the zinc metal anode. They can also increase the electrochemical stability of water, which widens the operating window of aqueous batteries [A. J. F. Romero et al. Polymers 2020, 12, 2812]. The benefits described are primarily related to chemically cross-linked polymer gels and polyacrylamide-based gels, which are the most promising option due to their hydrophilic amide groups [Z. Niu et al. Chem. Eur. J. 2019, 25, 14480-14494]. The cross-linked polymer gel structure traps water molecules, resulting in higher electrochemical stability of water, and amide groups improve this trapping ability [T T. Shikata. Phys. Chem. Chem. Phys. 2014, 16, 13262-13270]. Additionally, polymer gel electrolytes, especially polyacrylamide-based gels, can be modified using methods such as grafting, copolymerization, and dual cross-linking. A promising crystal-type poly(acrylamide-co-[2-(Methacryloyloxy) ethyl] dimethyl-3-sulfopropyl)-based gel electrolyte was suggested by Q. Wang et al. [Adv. Mater. 2019, 1900248] for use in supercapacitor systems. The suggested copolymer was obtained through polymerization in an electrolyte solution. The second component of the copolymer is [2-(Methacryloyloxy) ethyl] dimethyl-(3-sulfopropyl), which has a zwitterionic structure, it contains positive and negative ionic charges in the same polymer backbone. This that provide such advantages as high ion conductivity and powerful water retention ability, which makes achievable a wide potential window up to 2.4 volts [C. H. Chung et al. Electrochimica Acta 2019, 319, 672-681]. However, the disadvantage of this analog is the inability to use the electrolyte at a voltage above 2.4 V.

A patent (No. U.S. Ser. No. 01/095,7939B2, 2021) is known for a polyacrylamide hydrogel electrolyte for flexible zinc-ion batteries, containing only acrylamide in the composition of the crosslinked polymer matrix. The disadvantage of this analogue is the absence of any information about the possible use of the polyacrylamide hydrogel electrolyte in the potential range above 2 volts.

In the present invention a cross-linked copolymer gel electrolyte for aqueous batteries is composed of acrylamide and [2-(Methacryloyloxy)ethyl]dimethyl-(3-sulfopropyl) monomers that copolymerize in an aqueous electrolyte solution.

The objective of this invention is a chemically cross-linked copolymer gel electrolyte for secondary aqueous batteries that increases the electrochemical stability of water thus widens the operating potential window.

The technical result consists of expanding the operating voltage range through a chemically cross-linked gel polymer electrolyte for secondary aqueous batteries. It provides high electrochemical stability and high ionic conductivity.

This technical result is achieved due to the fact that the invention proposes a cross-linked polymer, which consists of acrylamide (AA). [2-(Methacryloyloxy) ethyl] dimethyl-(3-sulfopropyl) (DMAPS) or one of the derivatives of sulfobetaine (hereinafter sulfobetaine) and N,N′-methylenebisacrylamide (MBA). AA and sulfobetaine are monomers, and MBA is a binding agent. Aqueous electrolyte is entrapped in the cross-linked copolymer structure to form a quasi-solid gel electrolyte material. The cross-linked polymer gel electrolyte is designed to be used both as a separator and as an electrolyte. It is placed between the negative (anode) and positive (cathode) electrodes. As a separator it prevents the direct contact of electrodes and as an electrolyte it provides a media where ions transfer from one electrode to another or from electrode into electrolyte and vice versa. Amide group of AA, cation and anion groups of DMAPS provide high ionic conductivity and strong water retention ability to the cross-linked polymer gel electrolyte. The invention due to high ionic conductivity possess a high reversibility of electrochemical reaction and high electrochemical stability because of water retained in strong hydrophilic structure. The gel polymer electrolyte consists of a chemically crosslinked copolymer matrix with an aqueous electrolyte solution trapped within the matrix. A copolymer consisting of acrylamide and [2-(Methacryloyloxy)ethyl]dimethyl-(3-sulfopropyl) monomers or derivatives thereof, and a crosslinking agent N,N′-methylenebisacrylamide. Electrolyte salts, as well as persulfate salts, can be used as a free radical polymerization initiator either together or separately. The polymerization can be carried out in aqueous solution or directly in electrolyte solutions followed by drying and immersion in an electrolyte, immersion without drying, or use without immersion.

This invention will be utilized in aqueous batteries as a cross-linked copolymer gel electrolyte and separator with a quasi-solid structure. The electrolyte is located between the anode and cathode electrodes, separates them, and provides an aqueous environment for ions. It ensures high electrochemical stability and high ionic conductivity.

Accordingly, the embodiments of the present invention provide solutions for a limited working potential window in aqueous batteries using a cross-linked polymer gel electrolyte.

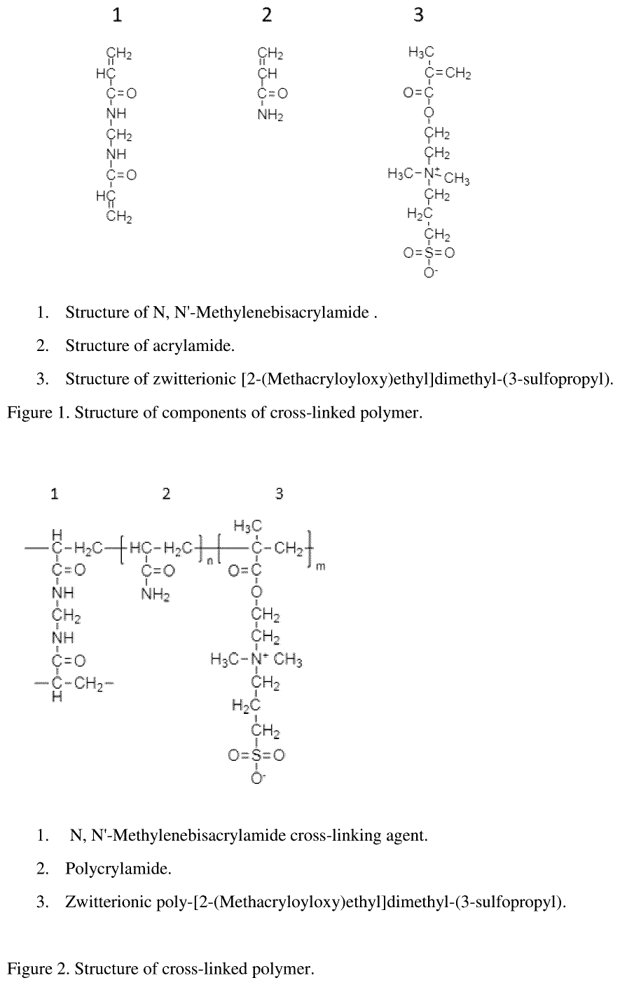

The invention is a quasi-solid cross-linked polymer matrix containing dissociated salt in its structure. The cross-linked polymer is composed of acrylamide (AA). [2-(Methacryloyloxy) ethyl] dimethyl-(3-sulfopropyl) (DMAPS), and N,N′-methylenebisacrylamide (MBA), as shown in FIG. 1. AA and DMAPS are monomers, and MBA is a cross-linking agent. The structure of the cross-linked polymer is shown in FIG. 2. An aqueous solution of the electrolyte salt is incorporated into the cross-linked polymer structure, forming a quasi-solid gel electrolyte material. The cross-linked polymer gel electrolyte is designed for use as both a separator and an electrolyte, placed between the negative (anodic) and positive (cathodic) electrodes. As a separator, it prevents direct contact between the electrodes, and as an electrolyte, it provides a medium in which ions move from one electrode to the other or from the electrode to the electrolyte and vice versa. The amide group of AA, the cationic and anionic groups of DMAPS, provide high ion conductivity and strong water-retention ability in the cross-linked polymer gel electrolyte. The invention, due to its high ion conductivity, has high reversibility of the electrochemical reaction and high electrochemical stability arising from strong water retention in the hydrophilic structure. Examples of sulfobetaine derivatives include [[2-(Methacryloyloxy) ethyl] dimethylammonio] propane-1-sulfonate. [[2-(Methacryloyloxy) ethyl] dimethylammonio] butane-1-sulfonate. [[2-(Acryloyloxy) ethyl] dimethylammonio] propane-1-sulfonate. [Bis2-(methacryloyloxy) ethylamine] propane-1-sulfonate. [(3-Methacrylamidopropyl) dimethylammonio] propane-1-sulfonate, [(3-Methacrylamidopropyl) dimethylammonio] butane-1-sulfonate, [(3-Acrylamidopropyl) dimethylammonio] propane-1-sulfonate.

Thermocatalytic free-radical polymerization of AA and DMAPS monomers, and crosslinking agent MBA is used to produce a crosslinked copolymer matrix. This matrix serves as a container for one or a mixture of different electrolyte solutions of various concentrations, such as zinc sulfate, zinc trifluoromethanesulfonate, zinc perchlorate, zinc chloride, zinc nitrate, and other electrolyte salts. To obtain a crosslinked copolymer gel electrolyte, the copolymer is immersed in the electrolyte solution. The thickness and shape of the resulting material depend on the design of the press mold.

Below, detailed embodiments of the invention will be described as examples, which are illustrated in the accompanying drawings. On the figures, a similar structure and/or composition will be identified using identical reference symbols.

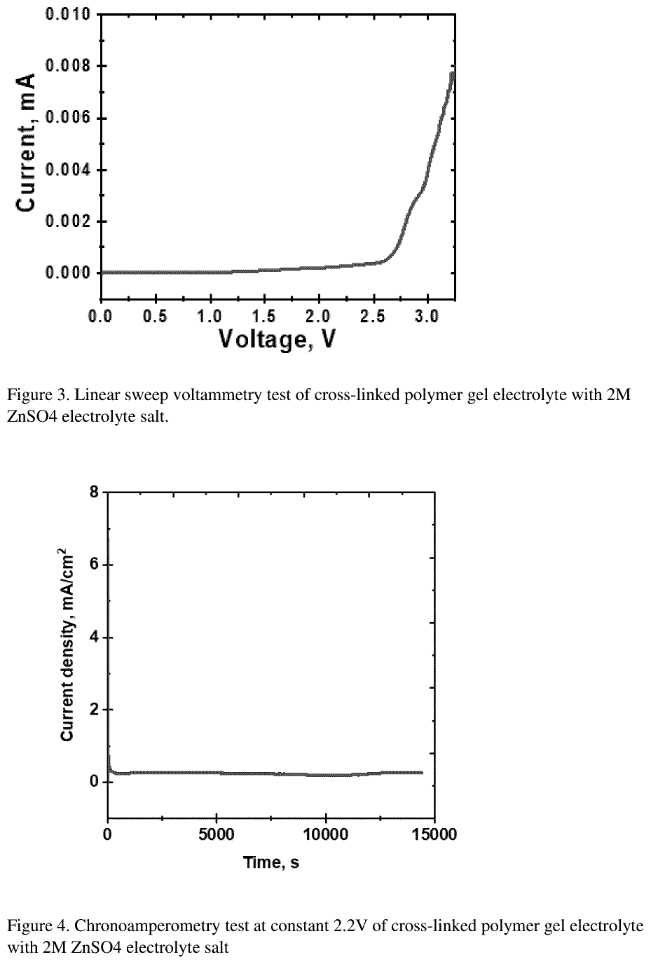

To conduct electrochemical tests, a symmetrical Swagelok cell made of carbon electrodes was used. Linear voltammetry electrochemical testing of the stitched copolymer gel electrolyte from Example 1 demonstrates high electrochemical stability up to 2.6 volts (FIG. 3), after which oxygen evolution reaction begins. Chronoamperometric testing (FIG. 4) at a constant potential of 2.2 volts demonstrates the stability of the polymer gel electrolyte without significant changes in current.

A rechargeable aqueous battery based on a crosslinked copolymer gel electrolyte consists of current collectors, active materials of the anode and cathode electrodes, a binder, and carbon conducting additives for the active materials. Any electrically conductive materials can be used as current collectors for the aqueous battery. The current collector for the aqueous battery with a working voltage window above 2 volts can be made of metallic titanium or carbon-based materials such as carbon paper, carbon nanotube paper, carbon cloth, graphite, and others. Any suitable active material can be used as the anode and cathode.

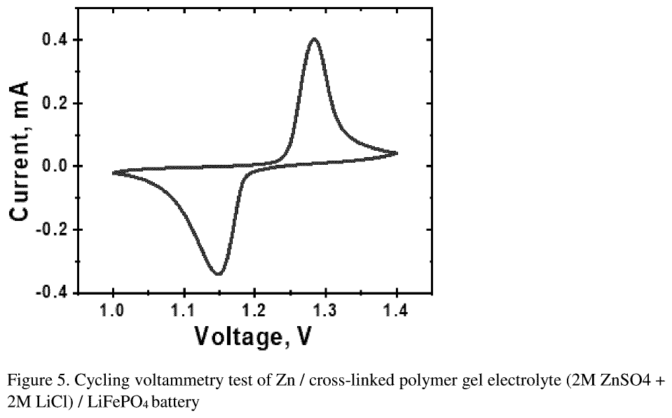

The rechargeable aqueous battery based on the cross-linked polymer gel electrolyte from the battery example used for cyclic voltammetry testing (FIG. 5) shows typical cathodic and anodic reaction pairs for these electrodes without any additional reactions.

The accompanying drawings, which are included in the specification and form a part of it, illustrate embodiments of the present invention and explain the principles of the invention in addition to the description.

FIG. 1 shows an example of the structure of components used for crosslinked copolymer gel electrolyte. The structure of N,N′-methylenebisacrylamide (N) is shown as 1, and the structure of acrylamide and [[2-(Methacryloyloxy) ethyl] dimethylammonio] propane-1-sulfonate (DMAPS) is shown as 2.

FIG. 2 shows an example of the structure of the cross-linked copolymer, where 1 represents N,N′-methylenebisacrylamide crosslinking agent, 2 represents polyacrylamide, and 3 represents poly-DMAPS.

FIG. 3 depicts the linear voltammetry test curve of the cross-linked copolymer gel electrolyte with a 2 M solution of ZnSO₄ salt as an example. The electrochemical test was carried out in a symmetrical cell made of carbon electrodes with a potential sweep rate of 1 mV/s. The cross-linked polymer gel electrolyte was prepared as described in Example 1.

FIG. 4 shows the chronoamperometric test curve at a constant voltage of 2.2 V of a cross-linked copolymer gel electrolyte with a 2 M solution of ZnSO₄ salt as an example. The electrochemical test was conducted in a symmetrical cell with carbon electrodes. The cross-linked polymer gel electrolyte was prepared as described in Preparation Example 1.

FIG. 5 shows the curve of cyclic voltammetry test results of the Zn electrolyte/cross-linked polymer gel with a 2 M ZnSO₄ and 2 M LiCl electrolyte solution/battery LifePO₄. The cross-linked polymer gel electrolyte was obtained using the preparation described in Preparation Example 2. The battery was assembled using the method described in the Battery Example.

### EXAMPLE OF PREPARATION 1

1 g of AA monomer powder and 1 g of DMAPS monomer powder are added to 8 mL of deionized water and stirred until fully dissolved. Then, 0.001 g of crosslinking agent is added to the solution and dissolved. The solution is thoroughly purged with clean argon while stirring constantly for at least 30 minutes to remove dissolved oxygen. Then, 0.005 g of potassium persulfate free radical polymerization initiator is added to the solution, dissolved, and the final solution is stirred for 1 hour at a temperature not exceeding 25° C. with further degassing in a vacuum chamber until bubbles no longer form in the solution, or subjected to 15 minutes of ultrasonic mixing at room temperature. The degassed solution is transferred into a 0.5 mm thick glass mold and kept at 60° C. for 3 hours. The resulting crosslinked copolymer gel is dried at 60° C. in a vacuum chamber to obtain a dried film, which is then immersed in a 2 Molar solution of ZnSO₄ electrolyte for 24 hours. A quasi-solid crosslinked polymer gel electrolyte is obtained.

### EXAMPLE OF PREPARATION 2

A quasi-solid cross-linked polymer gel electrolyte is obtained using the same method as described in Preparation Example 1, except that the electrolyte solution consists of 2 moles/liter of ZnSO₄ and 2 moles/liter of LiCl.

### EXAMPLE OF PREPARATION 3

The quasi-solid crosslinked polymer electrolyte gel is obtained by the same method as described in Example 1, except that 8 mL of deionized water is replaced with a 2.5 M solution of Zn (CF₃SO₃)₂ electrolyte, the electrolyte solution is purged with argon before adding AA and DMAPS, the potassium persulfate polymerization initiator is removed, Zn(CF₃SO₃)₂ is introduced, and free-radical polymerization is initiated. After the polymerization process, the next step is immersion in a 2.5 M Zn (CF₃SO₃)₂ solution without drying.

### EXAMPLE OF PREPARATION 4

A quasi-solid cross-linked polymer gel electrolyte is prepared using the same method as described in Example 1, except that 4-[[2-(methacryloyloxy) ethyl] dimethylammonio] butane-1-sulfonate was used as the sulfobetaine derivative.

### EXAMPLE OF PREPARATION 5

The quasi-solid cross-linked gel polymer electrolyte is obtained by the same method as described in preparation example 3, except that 4-[[2-(Methacryloyloxy) ethyl] dimethylammonio] butane-1-sulfonate was used as a derivative of sulfobetaine.

### EXAMPLE OF PREPARATION 6

A quasi-solid cross-linked gel polymer electrolyte is obtained by the same method as described in example 1, except that 0.5 g of 3-[(3-acrylamidopropyl) dimethylammonio] propanesulfonate was used as the sulfobetaine derivative, 1.5 g of AA was used, and 0.01 g of MBA was used.

### EXAMPLE OF BATTERY

A rechargeable aqueous battery is assembled by assembling a cathode, a cross-linked copolymer gel electrolyte, and an anode into a battery cell. A 0.5 mm thick metallic zinc anode was used as is without additional treatment. Metallic zinc is also used as an anode current collector. A commercial LiFePO₄ cathode (MTI corp.) is mixed with acetylene black powder and a binder polyvinylidene fluoride (PVDF) in a mass ratio of 90:6:4, respectively. The mixture was dissolved in the organic solvent N-methyl-2-pyrrolidone (NMP), and the resulting suspension was poured onto a current collector made of copy paper and dried. The obtained cathode has a mass distribution of active material of about 3-4 mg/cm2. The sewn polymer gel electrolyte was obtained using the preparation described in Example 2.

1. A cross-linked copolymer gel electrolyte (GPE) based on water and acrylamide (AA) for rechargeable aqueous batteries, characterized in that the copolymer also contains one of the following monomers: [2-(methacryloyloxy) ethyl] dimethyl-(3-sulfopropyl) ammonium hydroxide (DMAPS) and their derivatives, as well as a crosslinking agent N, N′-methylenebisacrylamide (MBA).

2. The GPE (or copolymer) according to paragraph 1 of the invention formula, characterized in that the water may be deionized and its mass content may range from 5% to 80%.

3. The GPE according to paragraph 1 of the invention formula, characterized in that the mass percentage ratio of AA:DMAPS monomers may range from 95:5 to 5:95.

4. The GPE according to paragraph 1 of the invention formula, characterized in that the mass percentage content of the crosslinking agent MBA relative to the total mass of AA and DMAPS monomers may range from 0.05% to 5%.

5. The GPE according to paragraph 1 of the invention formula, characterized in that it contains an aqueous solution of one or a combination of electrolyte salts at different concentrations, having the formula M+X−, where:
M+—Zn²⁺, Mn²⁺, Li⁺, Co²⁺
X⁻— Cl⁻, SO₄²⁻, NO₃⁻, ClO₄⁻, CF₃SO₃⁻, OH⁻
